(19) United States
(12) Patent Application Publication
(10) Pub. No.: US 2026/0183667 A1
(43) Pub. Date: Jul. 2, 2026

(54) INTERACTIVE CHARACTER SYSTEM WITH TOY CHARACTER RECOGNITION AND RESPONSE CUSTOMIZATION

(71) Applicant: Zebbie Limited, Central (HK)

(72) Inventors: Richard Bibbey, London (GB); Qia Li, Hong Kong (HK)

(21) Appl. No.: 19/007,362

(22) Filed: Dec. 31, 2024

(51) Int. Cl. A63F 13/58; G06K 19/07

(52) U.S. Cl. CPC A63F 13/58; G06K 19/0723

(57) ABSTRACT

This disclosure provides systems, methods, and devices that enable interactive sessions between users and physical toy characters using a computing device. In one aspect, a method is provided that includes receiving, by a first computing device, identifiers associated with physical toy characters and user inputs, such as interaction mode selections or audio inputs. The method involves transmitting a session request based on this information to a second computing device, which generates a response using a machine learning model. The response, which may include narrative stories, conversations, or adventures involving the toy characters, is then presented to the user through audio or visual outputs. Additionally, features such as haptic feedback, character-specific settings, and environmental context data can enhance the interaction. The system can also retrieve educational content and integrate accessories and interactions between multiple toy characters, thereby offering a rich, personalized experience for the user. Other aspects are provided.

### BACKGROUND

Interactive toys have helped enhance entertainment and education for individuals, offering users engaging experiences that combine play with learning. These toys may be designed to respond to user actions, fostering a sense of involvement and immersion that enhances the overall play experience. Engagement through interactive play aids in developing cognitive and social skills, particularly in children, by encouraging exploration, creativity, and communication.

Over time, interactive toys have evolved from simple mechanical devices to more sophisticated products that incorporate electronics and basic computing capabilities. Features such as lights, sounds, and movement may be used to capture attention and respond to user inputs. These interactions not only entertain but also provide developmental benefits by stimulating sensory experiences and encouraging problem-solving.

### SUMMARY

The present techniques relate to an interactive toy character system that leverages artificial intelligence and machine learning, such as large language models (LLMs), to facilitate real-time, intelligent interactions between physical toy characters and users. The system comprises physical toy characters embedded with identification carriers, user-facing computing devices with recognition capabilities, and a backend infrastructure that processes inputs and generates responses. By detecting and recognizing toy characters through technologies like NFC, RFID, or visual markers, the computing devices can transmit user inputs to the backend, which then utilizes machine learning models to generate contextually appropriate responses. These responses may include text, audio, visual content, or haptic feedback, providing an engaging and personalized play experience. The techniques support various interaction modes, multi-character interactions, and can be extended to include accessories and multi-user scenarios.

In a first aspect, a method includes receiving, by a first computing device, a first identifier associated with a first physical toy character; transmitting, by the first computing device, a request for an interactive session to a second computing device, where the request is determined based on the user input and the character identification data; receiving, by the first computing device, a response from the second computing device, where the response is generated based on the first identifier and the user input; and presenting, by the first computing device, the response to the user.

In a second aspect according to the first aspect, the method further includes receiving, by the first computing device, user input from a user, where the request is determined based on the user input, and where the response is generated based on the user input.

In a third aspect according to the second aspect, the user input includes a selection from a plurality of interaction modes, including at least one of: a historian mode in which the response is determined to include historical facts related to the toy character; a storyteller mode in which the response is determined to include a narrative story involving the physical toy character and the user; a face-to-face mode in which the response is determined to include conversations between the user and the physical toy character; an adventure mode in which the response is determined to include interactive narratives where the user participates in adventures with the physical toy character; a biographer mode in which determining the response includes determining a digital twin of the user by collecting personal information associated with the user, where the response is determined based on the personal information; a music mode in which the response may include music generated by artificial intelligence in real time; or a combination thereof.

In a fourth aspect according to any one of the second or third aspects, the user input comprises audio input captured via a microphone of the first computing device.

In a fifth aspect according to any one of the first through fourth aspects, presenting the response to the user includes converting text included in the response into audio data and outputting the audio data via a speaker of the first computing device, the first physical toy character, or a combination thereof.

In a sixth aspect according to any one of the first through fifth aspects, presenting the response further includes providing haptic feedback to the user via the first computing device.

In a seventh aspect according to the sixth aspect, the haptic feedback is provided via the first physical toy character through one or more actuators of the first physical toy controlled by the first computing device.

In an eighth aspect according to any one of the first through seventh aspects, the method further includes detecting a second identifier associated with a second physical toy character, and the request is determined based on the first identifier and the second identifier.

In a ninth aspect according to the eighth aspect, presenting the response includes outputting an interaction between the first physical toy character and the second toy character.

In a tenth aspect according to any one of the first through ninth aspects, the method further includes extracting, by the first computing device, at least one feature, at least one phrase, at least one keyword, or a combination thereof from the audio input, where the request includes the at least one feature, at least one phrase, at least one keyword, or a combination thereof.

In an eleventh aspect according to any one of the first through tenth aspects, detecting the first identifier comprises receiving the first identifier from a wireless tag contained within the first physical toy character.

In a twelfth aspect according to the eleventh aspect, the wireless tag is an NFC tag, an RFID tag, or a combination thereof.

In a thirteenth aspect, a method includes receiving, by a second computing device, from a first computing device over a network, a request for an interactive session, where the request comprises at least one identifier corresponding to a physical toy character; determining, by the second computing device, a response to the request using a machine learning model, where the response is based on the at least one identifier; and transmitting, by the second computing device, the response to the first computing device for presentation to the user.

In a fourteenth aspect according to the thirteenth aspect, the request comprises a first identifier associated with a first physical toy character and a second identifier associated with a second physical toy character, and determining the response includes determining a response to include an interaction between the first physical toy character and the second physical toy character.

In a fifteenth aspect according to any one of the thirteenth or fourteenth aspects, the machine learning model is trained based on content specific to at least one character associated with the at least one identifier.

In a sixteenth aspect according to any one of the thirteenth through fifteenth aspects, the request further includes an indication of an accessory connected to the physical toy character, and determining the response includes adjusting the response based on the accessory.

In a seventeenth aspect according to any one of the thirteenth through sixteenth aspects, the request further includes environmental context data, and the response is determined based on the environmental context data.

In an eighteenth aspect according to any one of the thirteenth through seventeenth aspects, the method further includes retrieving information from a knowledge base associated with the toy character to generate the response.

In a nineteenth aspect according to the eighteenth aspect, the method further includes retrieving character-specific settings associated with the at least one identifier, the first computing device, the first physical toy character, or a combination thereof, and determining the response based on the character-specific settings.

In a twentieth aspect according to any one of the thirteenth through nineteenth aspects, determining content difficulty levels or topics of the response is based on user characteristics, previous interactions, user preferences, or a combination thereof.

In a twenty-first aspect according to any one of the thirteenth through twentieth aspects, the method further includes determining, by the second computing device, an educational curriculum associated with the user, where the response is determined based on the educational curriculum.

In a twenty-second aspect according to any one of the thirteenth through twenty-first aspects, the method further includes integrating haptic feedback instructions into the response, and transmitting the instructions to the first computing device for providing tactile feedback to the user.

In a twenty-third aspect according to any one of the thirteenth through twenty-second aspects, determining the response comprises selecting an interaction mode from a plurality of interaction modes, including at least one of: a historian mode in which the response is determined to include historical facts related to the toy character; a storyteller mode in which the response is determined to include a narrative story involving the physical toy character and the user; a face-to-face mode in which the response is determined to include conversations between the user and the physical toy character; an adventure mode in which the response is determined to include interactive narratives where the user participates in adventures with the physical toy character; a biographer mode in which determining the response includes determining a digital twin of the user by collecting personal information associated with the user, where the response is determined based on the personal information; a music mode in which the response may include music generated by artificial intelligence in real time; or a combination thereof.

In a twenty-fourth aspect, a system includes a processor and a memory storing instructions which, when executed by the processor, cause the processor to perform operations including receiving, by a first computing device, a first identifier associated with a first physical toy character; transmitting, by the first computing device, a request for an interactive session to a second computing device, where the request is determined based on the user input and the character identification data; receiving, by the first computing device, a response from the second computing device, where the response is generated based on the first identifier and the user input; and presenting, by the first computing device, the response to the user.

In a twenty-fifth aspect according to the twenty-fourth aspect, the operations further include receiving, by the first computing device, user input from a user, where the request is determined based on the user input, and where the response is generated based on the user input.

In a twenty-sixth aspect according to the twenty-fifth aspect, the user input includes a selection from a plurality of interaction modes, including at least one of: a historian mode in which the response is determined to include historical facts related to the toy character; a storyteller mode in which the response is determined to include a narrative story involving the physical toy character and the user; a face-to-face mode in which the response is determined to include conversations between the user and the physical toy character; an adventure mode in which the response is determined to include interactive narratives where the user participates in adventures with the physical toy character; a biographer mode in which determining the response includes determining a digital twin of the user by collecting personal information associated with the user, where the response is determined based on the personal information; a music mode in which the response may include music generated by artificial intelligence in real time; or a combination thereof.

In a twenty-seventh aspect according to any one of the twenty-fifth or twenty-sixth aspects, the user input comprises audio input captured via a microphone of the first computing device.

In a twenty-eighth aspect according to any one of the twenty-fourth through twenty-seventh aspects, presenting the response to the user includes converting text included in the response into audio data and outputting the audio data via a speaker of the first computing device, the first physical toy character, or a combination thereof.

In a twenty-ninth aspect according to any one of the twenty-fourth through twenty-eighth aspects, presenting the response further includes providing haptic feedback to the user via the first computing device.

In a thirtieth aspect according to the twenty-ninth aspect, the haptic feedback is provided via the first physical toy character through one or more actuators of the first physical toy controlled by the first computing device.

In a thirty-first aspect according to any one of the twenty-fourth through thirtieth aspects, the operations further include detecting a second identifier associated with a second physical toy character, and the request is determined based on the first identifier and the second identifier.

In a thirty-second aspect according to the thirty-first aspect, presenting the response includes outputting an interaction between the first physical toy character and the second toy character.

In a thirty-third aspect according to any one of the twenty-fourth through thirty-second aspects, the operations further include extracting, by the first computing device, at least one feature, at least one phrase, at least one keyword, or a combination thereof from the audio input, where the request includes the at least one feature, at least one phrase, at least one keyword, or a combination thereof.

In a thirty-fourth aspect according to any one of the twenty-fourth through thirty-third aspects, detecting the first identifier comprises receiving the first identifier from a wireless tag contained within the first physical toy character.

In a thirty-fifth aspect according to the thirty-fourth aspect, the wireless tag is an NFC tag, an RFID tag, or a combination thereof.

In a thirty-sixth aspect, a system includes a processor and a memory storing instructions which, when executed by the processor, cause the processor to perform operations including receiving, by a second computing device, from a first computing device over a network, a request for an interactive session, where the request comprises at least one identifier corresponding to a physical toy character; determining, by the second computing device, a response to the request using a machine learning model, where the response is based on the at least one identifier; and transmitting, by the second computing device, the response to the first computing device for presentation to the user.

In a thirty-seventh aspect according to the thirty-sixth aspect, the request comprises a first identifier associated with a first physical toy character and a second identifier associated with a second physical toy character, and the operations include determining a response to include an interaction between the first physical toy character and the second physical toy character.

In a thirty-eighth aspect according to any one of the thirty-sixth or thirty-seventh aspects, the machine learning model is trained based on content specific to at least one character associated with the at least one identifier.

In a thirty-ninth aspect according to any one of the thirty-sixth through thirty-eighth aspects, the request further includes an indication of an accessory connected to the physical toy character, and the operations include adjusting the response based on the accessory.

In a fortieth aspect according to any one of the thirty-sixth through thirty-ninth aspects, the request further includes environmental context data, and the response is determined based on the environmental context data.

In a forty-first aspect according to any one of the thirty-sixth through fortieth aspects, the operations further include retrieving information from a knowledge base associated with the toy character to generate the response.

In a forty-second aspect according to the forty-first aspect, the operations further include retrieving character-specific settings associated with the at least one identifier, the first computing device, the first physical toy character, or a combination thereof; and determining the response based on the character-specific settings.

In a forty-third aspect according to any one of the thirty-sixth through forty-second aspects, determining content difficulty levels or topics of the response is based on user characteristics, previous interactions, user preferences, or a combination thereof.

In a forty-fourth aspect according to any one of the thirty-sixth through forty-third aspects, the operations further include determining, by the second computing device, an educational curriculum associated with the user, where the response is determined based on the educational curriculum.

In a forty-fifth aspect according to any one of the thirty-sixth through forty-fourth aspects, the operations further include integrating haptic feedback instructions into the response, and transmitting the instructions to the first computing device for providing tactile feedback to the user.

In a forty-sixth aspect according to any one of the thirty-sixth through forty-fifth aspects, determining the response comprises selecting an interaction mode from a plurality of interaction modes, including at least one of: a historian mode in which the response is determined to include historical facts related to the toy character; a storyteller mode in which the response is determined to include a narrative story involving the physical toy character and the user; a face-to-face mode in which the response is determined to include conversations between the user and the physical toy character; an adventure mode in which the response is determined to include interactive narratives where the user participates in adventures with the physical toy character; a biographer mode in which determining the response includes determining a digital twin of the user by collecting personal information associated with the user, where the response is determined based on the personal information; a music mode in which the response may include music generated by artificial intelligence in real time; or a combination thereof.

In a forty-seventh aspect, a non-transitory computer-readable medium stores instructions which, when executed by a processor, cause the processor to perform operations including receiving, by a first computing device, a first identifier associated with a first physical toy character; transmitting, by the first computing device, a request for an interactive session to a second computing device, where the request is determined based on the user input and the character identification data; receiving, by the first computing device, a response from the second computing device, where the response is generated based on the first identifier and the user input; and presenting, by the first computing device, the response to the user.

In a forty-eighth aspect according to the forty-seventh aspect, the operations further include receiving, by the first computing device, user input from a user, where the request is determined based on the user input, and where the response is generated based on the user input.

In a forty-ninth aspect according to the forty-eighth aspect, the user input includes a selection from a plurality of interaction modes, including at least one of: a historian mode in which the response is determined to include historical facts related to the toy character; a storyteller mode in which the response is determined to include a narrative story involving the physical toy character and the user; a face-to-face mode in which the response is determined to include conversations between the user and the physical toy character; an adventure mode in which the response is determined to include interactive narratives where the user participates in adventures with the physical toy character; a biographer mode in which determining the response includes determining a digital twin of the user by collecting personal information associated with the user, where the response is determined based on the personal information; a music mode in which the response may include music generated by artificial intelligence in real time; or a combination thereof.

In a fiftieth aspect according to any one of the forty-eighth or forty-ninth aspects, the user input comprises audio input captured via a microphone of the first computing device.

In a fifty-first aspect according to any one of the forty-seventh through fiftieth aspects, presenting the response to the user includes converting text included in the response into audio data and outputting the audio data via a speaker of the first computing device, the first physical toy character, or a combination thereof.

In a fifty-second aspect according to any one of the forty-seventh through fifty-first aspects, presenting the response further includes providing haptic feedback to the user via the first computing device.

In a fifty-third aspect according to the fifty-second aspect, the haptic feedback is provided via the first physical toy character through one or more actuators of the first physical toy controlled by the first computing device.

In a fifty-fourth aspect according to any one of the forty-seventh through fifty-third aspects, the operations further include detecting a second identifier associated with a second physical toy character, and the request is determined based on the first identifier and the second identifier.

In a fifty-fifth aspect according to the fifty-fourth aspect, presenting the response includes outputting an interaction between the first physical toy character and the second toy character.

In a fifty-sixth aspect according to any one of the forty-seventh through fifty-fifth aspects, the operations further include extracting, by the first computing device, at least one feature, at least one phrase, at least one keyword, or a combination thereof from the audio input, where the request includes the at least one feature, at least one phrase, at least one keyword, or a combination thereof.

In a fifty-seventh aspect according to any one of the forty-seventh through fifty-sixth aspects, detecting the first identifier comprises receiving the first identifier from a wireless tag contained within the first physical toy character.

In a fifty-eighth aspect according to the fifty-seventh aspect, the wireless tag is an NFC tag, an RFID tag, or a combination thereof.

In a fifty-ninth aspect, a non-transitory computer-readable medium stores instructions which, when executed by a processor, cause the processor to perform operations including receiving, by a second computing device, from a first computing device over a network, a request for an interactive session, where the request comprises at least one identifier corresponding to a physical toy character; determining, by the second computing device, a response to the request using a machine learning model, where the response is based on the at least one identifier; and transmitting, by the second computing device, the response to the first computing device for presentation to the user.

In a sixtieth aspect according to the fifty-ninth aspect, the request comprises a first identifier associated with a first physical toy character and a second identifier associated with a second physical toy character, and determining the response includes determining a response to include an interaction between the first physical toy character and the second physical toy character.

In a sixty-first aspect according to any one of the fifty-ninth or sixtieth aspects, the machine learning model is trained based on content specific to at least one character associated with the at least one identifier.

In a sixty-second aspect according to any one of the fifty-ninth through sixty-first aspects, the request further includes an indication of an accessory connected to the physical toy character, and determining the response includes adjusting the response based on the accessory.

In a sixty-third aspect according to any one of the fifty-ninth through sixty-second aspects, the request further includes environmental context data, and the response is determined based on the environmental context data.

In a sixty-fourth aspect according to any one of the fifty-ninth through sixty-third aspects, the operations further include retrieving information from a knowledge base associated with the toy character to generate the response.

In a sixty-fifth aspect according to the sixty-fourth aspect, the operations further include retrieving character-specific settings associated with the at least one identifier, the first computing device, the first physical toy character, or a combination thereof, and determining the response based on the character-specific settings.

In a sixty-sixth aspect according to any one of the fifty-ninth through sixty-fifth aspects, determining content difficulty levels or topics of the response is based on user characteristics, previous interactions, user preferences, or a combination thereof.

In a sixty-seventh aspect according to any one of the fifty-ninth through sixty-sixth aspects, the operations further include determining, by the second computing device, an educational curriculum associated with the user, where the response is determined based on the educational curriculum.

In a sixty-eighth aspect according to any one of the fifty-ninth through sixty-seventh aspects, the operations further include integrating haptic feedback instructions into the response, and transmitting the instructions to the first computing device for providing tactile feedback to the user.

In a sixty-ninth aspect according to any one of the fifty-ninth through sixty-eighth aspects, determining the response comprises selecting an interaction mode from a plurality of interaction modes, including at least one of: a historian mode in which the response is determined to include historical facts related to the toy character; a storyteller mode in which the response is determined to include a narrative story involving the physical toy character and the user; a face-to-face mode in which the response is determined to include conversations between the user and the physical toy character; an adventure mode in which the response is determined to include interactive narratives where the user participates in adventures with the physical toy character; a biographer mode in which determining the response includes determining a digital twin of the user by collecting personal information associated with the user, where the response is determined based on the personal information; a music mode in which the response may include music generated by artificial intelligence in real time; or a combination thereof.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 depicts a system for machine-learning based generative toy interactions according to one aspect of the present disclosure.

FIG. 2 illustrates an example embodiment of a device according to one aspect of the present disclosure.

FIG. 3 illustrates physical toy characters according to aspects of the present disclosure.

FIG. 4 depicts a method for machine-learning based generative toy interactions according to one aspect of the present disclosure.

FIG. 5 depicts a method for machine-learning based generative toy interactions according to one aspect of the present disclosure.

FIG. 6 illustrates a computer system according to one aspect of the present disclosure.

### DETAILED DESCRIPTION OF EXAMPLE EMBODIMENTS

Existing toy systems often provide limited interactivity, primarily relying on pre-recorded audio or scripted responses that do not adapt to the user's input in a meaningful way. Traditional audio toys lack the ability to engage in dynamic, two-way conversations, and do not offer personalized or context-aware interactions. While some advanced toys incorporate basic sensors or pre-set dialogues, they do not leverage artificial intelligence to create genuinely responsive and evolving interactions.

In prior systems, interactions are typically confined to simple trigger-response mechanisms, where a button press or a specific action elicits a fixed response from the toy. These systems do not account for the user's unique inputs, preferences, or previous interactions. Additionally, the content provided is often static, failing to maintain long-term engagement or provide educational value tailored to the user's developmental stage. For example, traditional toys do not facilitate immersive educational experiences such as interactive historical explorations, where users can engage with characters to learn about different time periods or historical events in a dynamic, engaging manner. Another limitation of existing techniques is the lack of seamless integration between physical toys and digital content. While some toys may interact with companion apps or platforms, they often require cumbersome setup procedures and do not offer real-time, conversational engagement. This gap between the physical and digital play experiences can diminish the user's immersion and limit the potential for enriched learning and entertainment.

One solution to this problem is to employ an interactive system that combines physical toy characters with advanced AI capabilities to enable real-time, personalized interactions. By embedding identification carriers, such as NFC or RFID tags, within the toy characters, the system allows computing devices to recognize and differentiate between various characters and accessories. This recognition facilitates dynamic interaction initiation based on the specific toys involved.

The computing devices can act as intermediaries, capturing user inputs through microphones, touchscreens, or cameras, and securely transmitting these inputs to other devices (such as backend infrastructure). Utilizing machine learning techniques such as large language models, the backend processes the inputs to generate contextually appropriate and engaging responses. These responses are tailored to the character's persona and the user's interaction history, enabling personalized and evolving dialogues.

The present techniques also support multiple interaction modes, such as storytelling, educational lessons, and role-playing adventures, enhancing the depth and variety of the user experience. By allowing for multi-character and multi-user interactions, the system creates a more immersive and socially enriching play environment. Additionally, the system can incorporate content moderation and safety checks to ensure that all interactions are appropriate and comply with privacy regulations.

In some aspects, the present disclosure provides techniques for interactive toy systems that may be particularly beneficial in enhancing user engagement and educational value. For example, by leveraging AI-driven responses, the system can offer personalized interactions that adapt to the user's preferences, developmental stage, and previous engagements. This personalization may improve the user's interest and investment in the play experience.

These techniques may also offer benefits over existing systems by seamlessly integrating physical toys with digital AI capabilities, creating a cohesive and immersive play environment. The real-time processing of user inputs and generation of contextually relevant responses may enhance the realism of interactions, fostering better social and communication skills in users. For end users, particularly children, the described techniques may provide a more engaging and educational experience. The inclusion of various interaction modes, such as educational storytelling and interactive adventures, can contribute to learning outcomes while maintaining entertainment value. Additionally, the system's ability to function across different devices and support offline modes may improve accessibility and convenience for users.

Furthermore, the techniques may improve the functioning of computing devices by optimizing resource utilization through edge computing and hybrid processing approaches. By handling certain processing tasks locally and offloading more intensive computations to the cloud, the system can ensure efficient performance while maintaining responsiveness and reducing latency.

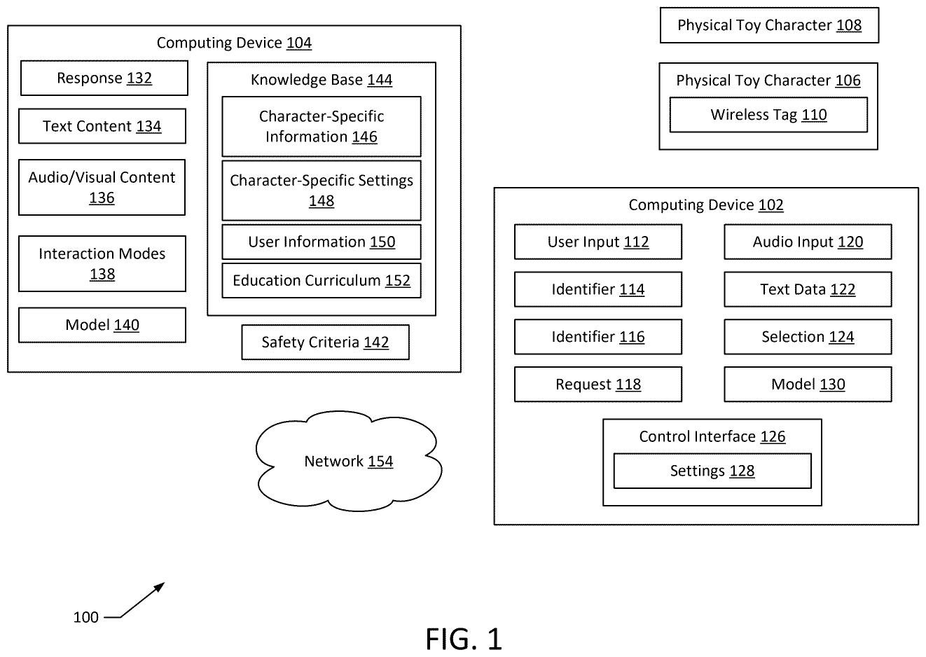

FIG. 1 depicts a system 100 for machine-learning based generative toy interactions according to one aspect of the present disclosure. The system 100 includes a first physical toy character 106, a second physical toy character 108, a first computing device 102, a second computing device 104, and a network 154. The first physical toy character 106 includes a wireless tag 110. The first computing device 102 includes user input 112, a first identifier 114, a second identifier 116, a request 118, audio input 120, text data 122, a selection 124, a control interface 126, and a local machine learning model 130. The control interface 126 includes settings 128. The second computing device 104 includes a response 132, text content 134, audio/visual content 136, interaction modes 138, a machine learning model 140, safety criteria 142, and a knowledge base 144. The knowledge base 144 includes character-specific information 146, character-specific settings 148, user information 150, and an education curriculum 152.

The first computing device 102 may serve as an interface between the user, the physical toy characters 106, 108 and an interactive system provided by the second computing device 104. Upon detecting a first identifier 114 associated with a first physical toy character 106, the first computing device 102 may receive user input 112, such as audio input 120 or text data 122. The user input 112 and the character identification data may be used to generate a request 118 for an interactive session.

In certain implementations, the first computing device 102 may maintain session details, including session identifiers, interaction history, previous user inputs, and conversational context. These session details may be stored locally on the first computing device 102 or synchronized with the second computing device 104. When generating the request 118, the first computing device 102 may include the session details along with the character identification data and the user input 112. By incorporating session information, the system can enable the second computing device 104 to generate responses that are contextually relevant, maintain conversational continuity, and reflect the user's interaction history.

The request 118 may be transmitted to the second computing device 104 via the network 154. The second computing device 104 may process the request 118 using one or more machine learning model 142 and may reference the knowledge base 146, which may include character-specific information 148 and user information 152. Based on these inputs, the second computing device 104 may generate a response 132 that may include text content 134, visual content 136, and audio content 138, tailored to the selected interaction modes 140 and adhering to safety criteria 144.

The first computing device 102 may receive the response 132 and may present it to the user through appropriate means, such as playing audio content 138 via a speaker, displaying visual content 136 on a screen, or providing haptic feedback. The control interface 126 and settings 128 may allow the user to customize the interaction experience.

Turning now to focus on the first computing device 102, which may be configured to receive a first identifier 114 associated with a first physical toy character 106. In certain implementations, the first computing device 102 may be a dedicated interactive device, such as the device 200 discussed in greater detail below. The dedicated interactive device may be a small, portable device resembling a telephone, equipped with Wi-Fi and Bluetooth connectivity, an NFC reader, a microphone, a speaker, and a minimal user interface. Alternatively, the first computing device 102 may be a mobile computing device like a smartphone, tablet, smart speaker, and the like, and may feature a touch screen, microphone, speaker, camera, and NFC or RFID capabilities. These devices may facilitate user interactions with the toy characters by recognizing the physical toy character 106 and capturing user input 112.

In certain implementations, detecting the first identifier 114 includes receiving the first identifier 114 from a wireless tag 110 contained within the first physical toy character 106. In certain implementations, the wireless tag 110 may be an NFC tag, an RFID tag, or a combination thereof. In such implementations, the first computing device 102 may read the wireless tag 110 using an integrated reader, such as an NFC reader or an RFID reader. When the physical toy character 106 is placed near or on the first computing device 102, the reader may detect the wireless tag 110 and retrieve the first identifier 114, which may uniquely identify that toy character. In certain implementations, the first identifier 114 may include visual markers such as QR codes or unique patterns on the physical toy character 106. The first computing device 102 may utilize its camera to capture images of the toy character and employ image recognition algorithms to detect the first identifier 114. Alternatively, the first computing device 102 may use other sensors, such as Bluetooth or infrared, to detect proximity or specific signals from the toy character.

The first computing device 102 may be configured to receive user input 112 from the user. In certain implementations, the user input 112 may include various forms of input such as voice commands, textual queries, touch inputs, and gestures. For example, a user might ask, “Can you tell me a story about space exploration?” requesting the system to generate a response 132 that may include a space-themed story involving the character corresponding to the first physical toy character 106. The user might also adjust settings 128 through the control interface 126, such as selecting an interaction mode (e.g., historian mode or adventure mode), setting the language preference, or adjusting the difficulty level of educational content. These inputs may directly influence the content and nature of the interactive session, allowing for a personalized experience.

In certain implementations, the user input 112 may include a selection 124 from a plurality of interaction modes 138, including at least one of a historian mode in which the response 132 may be determined to include historical facts related to the toy character, a storyteller mode in which the response 132 may be determined to include a narrative story involving the physical toy character and the user, a face-to-face mode in which the response 132 may be determined to include conversations between the user and the physical toy character, and an adventure mode in which the response 132 may be determined to include interactive narratives where the user participates in adventures with the physical toy character; a biographer mode in which determining the response 132 may include determining a digital twin of the user by collecting personal information associated with the user, the response 132 may be determined based on the personal information; an AI music mode in which the response 132 may include music generated by artificial intelligence in real time, either as background to other modes or as a standalone experience; or a combination thereof.

For example, in AI music mode, the user may request the toy character to play a song or compose music related to a specific theme or mood. The machine learning model 142 may generate original music content in real time, tailored to the user's preferences or the current interaction context. The generated music may be played through the first computing device 102's speakers, enhancing the interactive experience with personalized auditory content. In AI music mode, the computing device 104 may generate music content using the machine learning model 142, which may include neural network architectures trained for music composition. The response 132 may include original music pieces generated in real time based on the user's input, the character's themes, or the interaction context. For instance, if the user requests a cheerful song from the toy character, the system may compose and deliver a lively tune that aligns with the character's persona. The generated music may be synthesized and transmitted to the first computing device 102 for playback.

In certain implementations, the system 100 may also offer a static content mode, where the first computing device 102 plays back pre-recorded music, narrative stories, or other types of static content without real-time generation. For example, the user may select from a library of songs, audiobooks, or educational recordings stored locally on the first computing device 102 or accessible through the second computing device 104 via the network 156. The content may be associated with specific physical toy characters 106, 108, such that when a particular toy character is detected, the computing device 102 automatically plays content linked to that character.

In certain implementations, the user input 112 may be received through multiple modalities to accommodate different interaction preferences and device capabilities. These modalities may include audio input captured via a microphone, text input through a touch screen or keyboard, touch gestures detected on a touch-enabled surface, and physical gestures recognized by motion sensors or cameras.

For example, the user input 112 may include audio input 120 captured via a microphone of the first computing device 102, and the first computing device 102 may be configured to extract at least one feature, at least one phrase, at least one keyword, or a combination thereof from the audio input 120. In certain implementations, the computing device 102 may be further configured to perform noise reduction on the audio input 120 prior to transmitting the user input 112 to the second computing device 104.

In certain implementations, the first computing device 102 includes a touch screen, and receiving user input 112 includes detecting touch inputs on the touch screen. In certain implementations, receiving user input 112 includes receiving gestures detected by sensors on the first computing device 102, and processing the gestures as part of the user input 112. For example, the user may perform a swiping gesture on the touch screen of the first computing device 102 to navigate through options or content. In certain implementations, the first computing device 102 may utilize motion sensors or cameras to detect hand movements or body gestures, interpreting them as commands or responses. These gestures may be processed by the device's sensors and interpreted by software algorithms to generate corresponding user input 112.

The first computing device 102 may be configured to transmit a request 118 for an interactive session to a second computing device 104. The request 118 may be determined based on the user input 112 and the identifier 114. In certain implementations, the request 118 may be formulated by combining the character identification data from the first identifier 114 with the processed user input 112. For instance, if the user speaks a command like “Let's go on an adventure!” while interacting with a toy character representing an explorer, the first computing device 102 may capture the audio input 120, convert it to text data 122, and pair it with the character's identifier 114. The request 118 may include this combined information and may also incorporate any selected settings 128 or interaction modes 140.

The first computing device 102 may be configured to receive a response 132 from the second computing device 104. The response 132 may be generated based on the first identifier 114 and the user input 112, such as by a machine learning model 140. The first computing device 102 may then present the response 132 to the user. In certain implementations, the response 132 may be a structured data packet that includes content generated by the second computing device 104. The response 132 may contain text content 134, visual content 136, audio content 138, and metadata specifying how the content should be presented. The responses may be received as single discrete messages or as a stream of data for ongoing interactions, enabling real-time communication. For example, in a conversation mode, the response 132 may be streamed to allow for natural dialogue flow between the user and the toy character.

In certain implementations, the presentation of the response 132 may be adapted based on its content type. Text content 134 may be displayed on a screen, audio content 138 may be played through speakers, and visual content 136 such as images or videos may be shown on a display. The system determines the appropriate output modality to provide an engaging and coherent user experience.

In certain implementations, presenting the response 132 to the user includes converting text included in the response 132 into audio data and outputting the audio data via a speaker of the first computing device 102, the first physical toy character 106, or a combination thereof. For example, if the response 132 includes text data like “Once upon a time, in a faraway land . . . ”, the first computing device 102 may use text-to-speech conversion techniques to generate audio data. Techniques such as neural network-based text-to-speech (TTS) models may produce natural-sounding speech, which is then played through the device's speaker, allowing the user to listen to the story narrated by the toy character.

In certain implementations, presenting the response 132 further includes providing haptic feedback to the user via the first computing device 102. In certain implementations, the haptic feedback may be provided via the first physical toy character 106 through one or more actuators of the first physical toy controlled by the first computing device 102. Building on the previous example, if the story involves exciting events, the first computing device 102 may provide haptic feedback by vibrating or using actuators within the physical toy character 106 to mimic movements, enhancing the storytelling experience. For instance, the toy character may gently move, vibrate, or light up in synchronization with the narrative.

In certain implementations, the first computing device 102 includes a display screen, and presenting the response 132 to the user includes displaying visual content included in the response 132 on the display screen. In certain implementations, the visual content may include images or videos generated based on the character identification data, the user input 112, or a combination thereof. For example, the visual content 136 included in the response 132 may be an image generated by the second computing device 104 depicting the toy character in a fantasy setting. The first computing device 102 may display this image on its screen, allowing the user to see the character in the context of the story. If the device 102 supports video playback, short animated clips may also be presented.

In certain implementations, presenting the response 132 may include augmented reality content displayed via a camera and display of the first computing device 102, overlaying virtual elements onto real-world images. In certain implementations, presenting the response 132 may involve augmented reality (AR) content. For example, using the first computing device's camera and display, virtual elements such as the toy character's animated avatar may be overlaid onto the real-world environment captured by the camera. Technical details may include utilizing AR software frameworks that track the device's orientation and position to accurately render virtual content in alignment with the physical world.

The first computing device 102 may be configured to support interactions involving multiple physical toy characters. By detecting additional identifiers, such as the second identifier 116 associated with the second physical toy character 108, the system may facilitate interactive sessions that include multiple characters. This allows for more complex narratives and dialogues where characters may interact with each other and the user. In certain implementations, the first computing device 102 may detect a second identifier 116 associated with a second physical toy character 108, and the request 118 may be determined based on the first identifier 114, the second identifier 116, the user input 112, or a combination thereof (such as to include the first identifier 114 and the second identifier 116). In certain implementations, presenting the response 132 includes outputting an interaction between the first physical toy character 106 and the second toy character. This may include synchronizing dialogues among the multiple toy characters based on predefined interaction scripts or dynamically generated content included within the response 132. In certain implementations, interactions between the first physical toy character 106 and the second physical toy character 108 may involve the system generating dialogues or stories that feature both characters. In particular, the request 118 may include the identifiers for both characters, any relevant user input 112, or a combination thereof. The second computing device 104 may use this information to prompt the machine learning model 142 to create content where the characters interact. For example, a prompt to the machine learning model may be structured to include character profiles, their relationship, and the context provided by the user input 112, enabling the generation of coherent and engaging multi-character content.

In certain implementations, interactions involving multiple users may be managed by a single computing device 102. In certain implementations, the computing device 102 may facilitate interactive sessions where several users engage with the toy characters together using the same device. For example, during a collaborative storytelling session, multiple users may contribute to the narrative by providing voice inputs through a shared microphone or by making selections on a shared touch screen. The computing device 102 may capture these inputs from different users and integrate them into the interaction, allowing for collective decision-making and cooperative play.

In certain implementations, the system may support multi-user interactions where multiple users engage with the toy character simultaneously using separate computing devices 102. Scenarios may include group storytelling sessions or collaborative learning activities. The system may synchronize the interaction content among all participating devices to ensure a cohesive experience. This may be performed by assigning a shared session identifier to all participating computing devices 102. The devices may communicate with the second computing device 104, which manages the interaction state and ensures that responses are consistent across all devices. Real-time synchronization techniques and network protocols may be used to coordinate the delivery of content, allowing users to interact collaboratively.

The first computing device 102 may enter an offline mode when network connectivity to the second computing device 104 is unavailable, which may be detected through failed network requests or connectivity checks. In offline mode, the device may utilize a local machine learning model 130 to process user input 112 and generate local responses 132. In certain implementations, the capabilities of the local machine learning model 130 may differ from the capabilities of the machine learning model 140.

The first computing device 102 may be configured to store interaction history associated with the user and utilizing the history to personalize future interactions. In certain implementations, the interaction history may be stored on the first computing device 102, especially if it is a mobile device with sufficient storage capacity. Alternatively, the interaction history may be stored on the second computing device 104, allowing for centralized data management and access across multiple devices. The first computing device 102 may store a history of interactions with the user, such as past conversations, preferences, and achievements. This information may be used to personalize future interactions. For example, if the user previously expressed interest in animals, the system may incorporate animal themes into stories or suggest related activities.

The first computing device 102 may be configured to provide parental control features accessible through the control interface 126 or a companion app on another computing device. Parents or guardians may configure settings 128 to define permitted content, set time limits, and restrict certain interaction modes. In certain implementations, these settings 128 may be stored on the first computing device 102, while in other implementations, they may be stored and managed by the second computing device 104 to allow consistent enforcement across multiple devices. For example, a parent may disable the adventure mode during weekdays to prioritize educational activities or set the device to operate only during specific hours. The system may enforce these settings by filtering content and adjusting functionality accordingly. In particular, the computing device 102 may be configured to receive, via the parental control interface 126, one or more configuration settings 128 defining permitted content or interaction parameters and may enforce the configuration settings 128 during the interactive session by filtering or modifying user input 112 or responses 132 according to the settings 128.

In certain implementations, the system 100 may provide accessibility settings 128 to accommodate users with diverse needs. These settings may include adjustable speech rates for audio content, text size options for visual content, or high-contrast display modes. The first computing device 102 may adjust the presentation of the response 132 based on these settings. Users may modify these settings through user input 112, such as voice commands like “Speak slower” or preferences saved from previous interactions.

In certain implementations, such as when used by younger users, privacy protections may be essential. Therefore, communication between the first computing device 102 and the second computing device 104 may be conducted over a secure, encrypted channel, such as HTTPS with TLS encryption. This ensures that sensitive data, including user input 112 and personal information, is protected during transmission over the network 154.

Turning now to the second computing device 104, which may be configured to receive from a first computing device 102 over a network 154, a request 118 for an interactive session, the request 118 includes user input 112 and at least one identifier corresponding to a physical toy character.

In certain implementations, the request 118 may include additional data such as session identifiers, user preferences, or settings 128. This data may be structured in a predefined format like JSON or XML and transmitted securely over the network 154. User preferences and settings 128, such as selected interaction modes 138, language options, or accessibility features, may be included to further refine the response 132.

The second computing device 104 may be configured to determine a response 132 to the request 118 using a machine learning model 140. The response 132 may be determined based on the identifier and the user input 112. In certain implementations, the machine learning model 140 may be a large language model (LLM), such as a transformer-based model trained on text datasets to generate text in response to received prompts. Other types of models, including sequence-to-sequence models, recurrent neural networks, or generative adversarial networks, may also be incorporated. The machine learning model 140 may comprise multiple models working in conjunction to handle various aspects of processing. For example, one model may focus on natural language understanding to interpret user input 112, while another handles natural language generation to produce the response 132 based on the character identification data and interaction modes 138.

In certain implementations, the machine learning model 140 may be trained with curated content specific to the toy character. In certain implementations, the machine learning model 140 may be fine-tuned with character-specific content, including dialogues, personality traits, catchphrases, and backstory elements unique to each toy character. This fine-tuning process may involve training the model on curated datasets that reflect the character's mannerisms and speech patterns. By incorporating this specialized content, the model may generate responses that are consistent with the character's identity, providing authentic and immersive interactions. Techniques such as supervised learning with labeled data or transfer learning from general-purpose models to character-specific models may be employed. The model 140 may include components specialized for different content types, enabling the generation of rich multimedia responses. For example, the machine learning model 142 may generate character-specific music themes, visual illustrations, or even short animated sequences that correspond to the context of the interaction.

In certain implementations, the request 118 may include additional information beyond the user input 112 and/or character identification data, allowing the system to incorporate more context into the response 132. In certain implementations, the request 118 further may include an indication of an accessory connected to the first physical toy character 106, and processing the user input 112 includes adjusting the response 132 based on the accessory. Accessories connected to the first physical toy character 106 may be detected by the first computing device 102 through additional identifiers like NFC tags, RFID tags, or visual markers. These accessories may enhance or alter the toy character's capabilities or attributes. For example, attaching a “magic wand” accessory may enable the character to perform “magical” actions or stories. Processing the user input 112 may include adjusting the response 132 to reflect the presence of the accessory, generating content that incorporates or references the accessory in the interaction.

In certain implementations, the computing device 104 may adjust the response 132 based on environmental context data 122 received from the first computing device 102. In certain implementations, environmental context data 122 may include information such as location, time of day, weather conditions, or ambient light levels. This data may be determined and provided by the first computing device 102 (such as with the request 118). The second computing device 104 may use this information to tailor the response 132. For example, if the system detects it's evening, the toy character may suggest bedtime stories. If it's raining, the response 132 may include indoor activity suggestions, enhancing the relevance and personalization of the interaction.

In certain implementations, the knowledge base 144 may store information that aids the machine learning model 140 in generating accurate and contextually appropriate responses. The knowledge base may be implemented in various forms, such as relational databases, graph databases, document stores, vector databases, and the like. In particular, vector databases may store embeddings of textual or multimedia content, enabling efficient similarity searches to retrieve relevant information based on the semantic content of the user input 112. The machine learning model 142 may utilize retrieval-augmented generation (RAG) techniques, where the model retrieves relevant context from the knowledge base 146 to augment its responses. Multiple separate knowledge bases may be implements, which may store different types of information, such as character-specific information 146, educational content, or user interaction histories. For example, one knowledge base may contain facts about historical events for use in historian mode, while another holds language data for multilingual support. The second computing device 104 may retrieve information from the knowledge base 144 when processing the request 118 by querying relevant data based on the user input 112 and character identification data, such as by leveraging vector similarity searches to find the most relevant content. In certain implementations, determining the response may include retrieving character-specific information 146 from the knowledge base 144 associated with the toy character to generate the response 132. In additional or alternative implementations determining the response may include retrieving character-specific settings 128 associated with the character identification data stored on the first computing device 102, the first physical toy character 106, or a combination thereof. In certain implementations, determining the response 132 based on the character-specific settings 128. The character-specific information 146 and settings 148 may be structured as data entries containing attributes such as the character's backstory, personality traits, preferred vocabulary, and domain-specific knowledge relevant to the character's theme. This information may be stored in databases with fields that can be queried using the character identification data. For example, if a user interacts with a toy character representing a scientist, the system may query the knowledge base for scientific facts or terminology associated with that character.

In certain implementations, personalizing the response 132 includes adjusting content difficulty levels or topics based on user information 150 including user characteristics, previous interactions, user preferences, or a combination thereof. User data such as session histories, preferences, and past interactions may be collected and stored in the knowledge base 144 or a dedicated user information 150 repository. User characteristics may include age, language preference, and interests inferred from previous interactions. For example, if a user frequently engages in adventure stories, the system may prioritize adventure-themed content. The user profile may be created during initial setup or over time as the system accumulates data. Age-appropriate content may be selected by adjusting the complexity of language or topics based on the user's age group. Personalized adjustments may include modifying the difficulty level of educational content or tailoring stories to incorporate the user's favorite themes.

In certain implementations, the computing device 104 may integrate educational curriculum content to provide learning opportunities alongside entertainment during interactions. For example, the computing device 104 may be configured to determine an educational curriculum associated with the user, and the response 132 may be determined based on the educational curriculum. The educational curriculum may be uniquely associated with the user, provided by educators or parents, or derived from user characteristics like age and proficiency levels. This curriculum may influence all responses or be activated through specific user input 112. For example, if a parent sets the system to focus on vocabulary building, the response 132 may include new words and definitions during interactions. Technically, the system may tag curriculum content within the knowledge base 144 and configure the machine learning model 140 to incorporate this content when generating responses. The model may access educational modules aligned with the user's learning objectives, seamlessly blending education with engagement.

In particular, the system 100 may facilitate immersive educational experiences through features such as a “Time-Travel Machine” concept, where users can engage with the physical toy characters 106, 108 to explore different historical periods. The machine learning model 142 may generate interactive narratives that incorporate and describe various eras, providing historical facts, cultural context, and engaging stories that align with the educational curriculum. For example, if the curriculum focuses on ancient civilizations, the response 132 may include an adventure where the user and the toy character visit Ancient Egypt, interact with historical figures, and learn about the society, architecture, and customs of the time. The integration of the educational curriculum into such interactive narratives allows the system to tailor content to the user's learning objectives. Educators or parents may select specific historical periods or themes within the control interface 126 of the first computing device 102, and the computing device 104 may adjust the responses 132 accordingly. The knowledge base 146 may store detailed historical information, including dates, events, biographies, and cultural insights, which the machine learning model 142 can access to provide accurate and age-appropriate content. By embedding educational material within engaging stories and adventures, the system enhances knowledge retention and makes learning enjoyable.

Additionally, the system 100 may assess the user's comprehension by incorporating interactive elements such as quizzes or decision-making scenarios within the historical narratives. For instance, during a journey to the Renaissance period, the toy character may ask the user questions about key inventions or artworks of that era. The user's responses can influence the progression of the story, providing a gamified learning experience. The computing device 104 may adapt the difficulty of the questions based on the user's previous answers, ensuring that the content remains challenging yet accessible. Feedback provided through the response 132 can reinforce correct answers or gently correct misconceptions, supporting personalized learning pathways.

Moreover, the system 100 can support cross-curricular integration by linking historical content with other subjects such as geography, science, and language arts. For example, while exploring the Age of Exploration, the response 132 may include information about navigational techniques, the impact of voyages on world geography, and the linguistic influences of cultural exchanges. This multidisciplinary approach can provide a holistic educational experience, encouraging users to make connections between different areas of knowledge. The curriculum-based interactions may also be logged by the computing device 104, allowing educators or parents to review the user's progress through reports accessible via the control interface 126 or a companion application. These reports may include metrics such as topics covered, questions answered correctly, and areas that may require further attention. This feedback can inform future curriculum adjustments and support the user's educational development outside of the interactive sessions.

In certain implementations, the response 132 may vary in format based on the capabilities of the first computing device 102, the second computing device 104, and the physical toy characters. Devices equipped with displays may present visual content like images or videos, while others may rely on audio outputs. Some physical toy characters may have built-in lights or motors, allowing for haptic feedback or visual cues. The system may adjust the response 132 accordingly, ensuring compatibility and optimizing user experience by utilizing the available modalities for each device configuration.

In certain implementations, generating the response 132 further includes generating visual content by creating images or videos that correspond to the character identification data and the context of the user input 112. Visual content generation may utilize technologies such as generative adversarial networks (GANs), variational autoencoders, or other machine learning-based image synthesis methods. These technologies may create customized images or videos that align with the user input 112 and character identification data. For example, if a user asks for a picture of the toy character visiting the moon, the system may generate an image depicting that scenario. Visual content may also include augmented reality (AR) elements, where the first computing device 102 overlays digital content onto the real world through its camera. An example could be displaying the toy character appearing to stand on the user's desk, enhancing immersion and engagement.

In certain implementations, further including integrating haptic feedback instructions into the response 132, and transmitting the instructions to the first computing device 102 for providing tactile feedback to the user. Haptic feedback may include vibrations, movements, or tactile sensations delivered through actuators in the first computing device 102 or the physical toy character 106. These instructions may be encoded within the response 132 as control signals or metadata specifying the type and timing of feedback. For example, during an interactive story where the character encounters an earthquake, the device may gently vibrate to simulate the experience. This feedback correlates with the content, adding a sensory dimension to the interaction and enhancing user engagement.

The second computing device 104 may receive and store various settings, including user-specific preferences, session-specific configurations, and response-specific parameters. These settings may influence how the response 132 is generated and delivered, allowing the system to adapt to individual user needs, interaction contexts, and content requirements.

In certain implementations, the user input 112 may specify one or more interaction modes 138, and the response 132 may be determined accordingly. The user may select these modes through verbal commands, touch inputs, or settings in the control interface 126. In certain implementations, processing the request 118 includes selecting an interaction mode from a plurality of interaction modes 138, including at least one of a historian mode, a storyteller mode, a face-to-face mode, an adventure mode, and a biographer mode, as discussed above. In particular, in historian mode, the computing device 104 may use the character identification data to retrieve relevant historical information from the knowledge base 144. The model 140 may be prompted with instructions like, “Provide an informative explanation about [historical topic] suitable for a young audience.” For example, if the toy character represents a figure from ancient Greece, the response 132 may include anecdotes about Greek mythology. Similarly, in storyteller mode, the computing device 104 may determine narrative stories involving the physical toy character and the user. The model 140 may be configured to create imaginative and engaging tales, using prompts such as, “Compose an adventurous story featuring [character name] and [user name] exploring a magical world.” In face-to-face mode, the model 140 may be prompted to maintain context-aware dialogue, using phrases like, “Engage in a friendly conversation with the user, responding appropriately to their questions,” and the computing device 104 system may utilize previous conversation history to ensure continuity. In adventure mode, the computing device may determine the response to creates interactive narrative where the user participates in adventures with the toy character. The model 140 may be guided with prompts like, “Develop an interactive quest for the user, offering choices that influence the outcome.” The response 132 may accordingly present scenarios requiring the user to make decisions, enhancing engagement through interactivity. In biographer mode, the computing device 104 may receive or retrieve personal information from the user to create a digital twin. The model 140 may be instructed to ask respectful questions and generate content based on the user information and the user's responses, and the response 132 may accordingly reflect the user's personality and preferences. Other modes may include educational quizzes, language learning, or music creation. The response 132 may incorporate gamification elements such as points, badges, or challenges. For example, the system may dynamically generate a math quiz appropriate to the user's skill level, adjusting difficulty based on previous performance. Personalization may involve selecting game themes that align with the user's interests, making the experience more engaging and motivating.

In certain implementations, the user input 112 includes audio data, and the computing device 104 may determine speech recognition on the audio data to determine text data 122 corresponding to the audio data, and may determine the response 132 based on the text data 122. In certain implementations, the computing device 104 may be further configured to extract at least one feature, at least one phrase, at least one keyword, or a combination thereof from the text. In such instances implementations, the response 132 may then be based on the at least one feature, at least one phrase, at least one keyword, or a combination thereof. Automatic speech recognition (ASR) may be performed using models like deep neural networks or hidden Markov models trained on diverse datasets, including children's speech patterns. Noise reduction techniques such as spectral subtraction or adaptive filtering may enhance audio quality to improve the accuracy of the ASR techniques. Once the audio is converted to text data 122, natural language processing methods may extract features, phrases, or keywords. For example, if the user says, “I want to hear a story about dragons,” the computing device 104 may identify keywords like “story” and “dragons,” informing the generation of a dragon-themed narrative in the response 132.

The response 132 may also be influenced by processing techniques like sentiment analysis and emotion recognition. Sentiment analysis may employ algorithms like logistic regression or neural networks to detect the emotional tone of the text data 122. For instance, if the user expresses frustration, the system may adjust the response 132 to be more sympathetic. Emotion recognition may analyze vocal cues such as pitch and tempo or textual cues like word choice. For example, detecting excitement in the user's voice may prompt the system to respond with matching enthusiasm, enhancing the emotional resonance of the interaction.

In certain implementations, the request 118 includes a first identifier 114 associated with a first physical toy character 106 and a second identifier 116 associated with a second physical toy character 108. In such instances, determining the response 132 includes determining a response 132 to include an interaction between the first physical toy character 106 and the second physical toy character 108. The system 100 may model interactions between multiple toy characters using the machine learning model 140, incorporating background facts, personality traits, and previous interactions. Customized dialogues may reflect the unique relationship between the characters and may be influenced by themes relevant to the user, such as teamwork or empathy. For example, if one character is playful and the other is studious, the interaction may balance fun with educational content.

In certain implementations, the computing device 104 may analyze the response 132 to identify any content that violates predefined safety criteria 142. If the response 132 satisfies the criteria, the computing device 104 may transmit the response 132 to the first computing device 102. If the response 132 does not satisfy the criteria, the computing device 104 may modify or filter the response 132 to determine a modified response that satisfies the criteria and the modified response may be transmitted to the first computing device 102. This process may include implementing filters and blacklists to screen for inappropriate language or topics. Machine learning models trained on datasets of undesirable content may detect subtle issues that simple filters might miss. If the response 132 contains flagged material, the system may modify it by rephrasing or replacing certain elements to meet safety criteria 142. For example, if violent content is detected, the system may alter the narrative to focus on non-violent themes, ensuring that all interactions are appropriate for the user. In certain instances, the model 140 may be prompted with an identification of problematic aspects of the response 132 in order to determine the modified response.

In certain implementations, supporting multi-user interactions multiple users interact simultaneously with the toy character via separate first computing devices 102, and processing the user input 112 may include synchronizing interaction content among the multiple users. In certain implementations, synchronizing the interaction content includes maintaining a shared session state accessible to the multiple first computing devices 102, coordinating responses 132 generated by the language model to ensure consistency across the devices, and resolving conflicting inputs by applying predefined rules or prioritizing inputs based on timestamps or user roles. The system 100 may identify and track multiple users and devices by assigning shared session identifiers and maintaining user profiles. Synchronization mechanisms like distributed databases, real-time messaging protocols (e.g., WebSockets), or messaging queues may ensure consistency across devices. In conflict resolution scenarios, such as two users issuing contradictory commands, the system may apply rules like prioritizing inputs based on timestamps, user roles, or prompting the users to reach a consensus, thereby maintaining a cohesive interaction.

The second computing device 104 may be configured to transmit the response 132 to the first computing device 102 for presentation to the user. The response 132 may be structured as a composite data object containing text content 134, audio content 138, visual content 136, and metadata such as timestamps or presentation instructions. Standard formats like JSON or XML may be used for organization. Multimedia files may be encoded in formats like MP3 for audio or JPEG/PNG for images. Transmission may utilize protocols such as HTTPS over TLS to ensure secure and reliable communication between the second computing device 104 and the first computing device 102.

In certain implementations, one or more functions described as performed by the first computing device 102 may instead be performed by the second computing device 104, and vice versa. The distribution of functionalities between the computing devices 102, 104 may depend on factors such as processing capabilities, storage availability, and network connectivity. For example, while the first computing device 102 may handle capturing user input 112 and presenting responses 132, the second computing device 104 may manage complex processing tasks such as running advanced machine learning models 142 or storing comprehensive interaction histories. This flexible allocation allows the system 100 to optimize performance and resource utilization based on the specific implementation and hardware configurations involved.

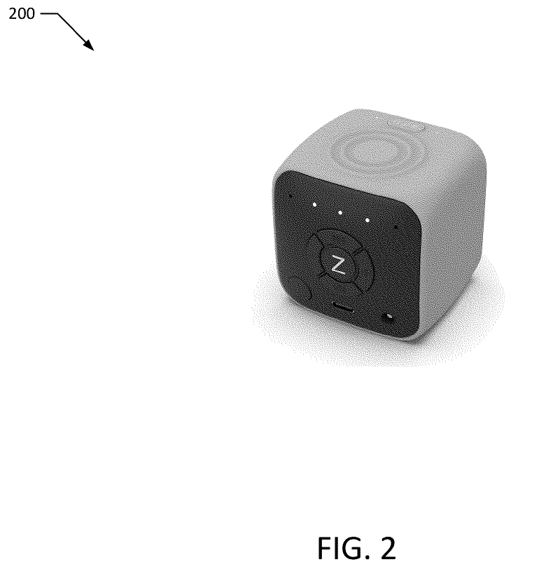

FIG. 2 illustrates an example embodiment of a device 200 according to one aspect of the present disclosure. The device 200 may be an exemplary implementation of the first computing device 102. Device 200 has a compact, cube-shaped design with rounded edges, emphasizing portability and user-friendly interaction suitable for users of various ages. A top surface of device 200 may include an embossed circular pattern, which may serve as a speaker grille, a touch-sensitive interface area, or the location of a wireless tag reader. This configuration may facilitate audio output for speech and sound playback, as well as interactive input capabilities through touch or gesture recognition. The front panel of device 200 may include a central control interface with multifunctional buttons for play, pause, and track navigation, allowing users to manage audio playback, navigate content, and control various interaction modes 138.

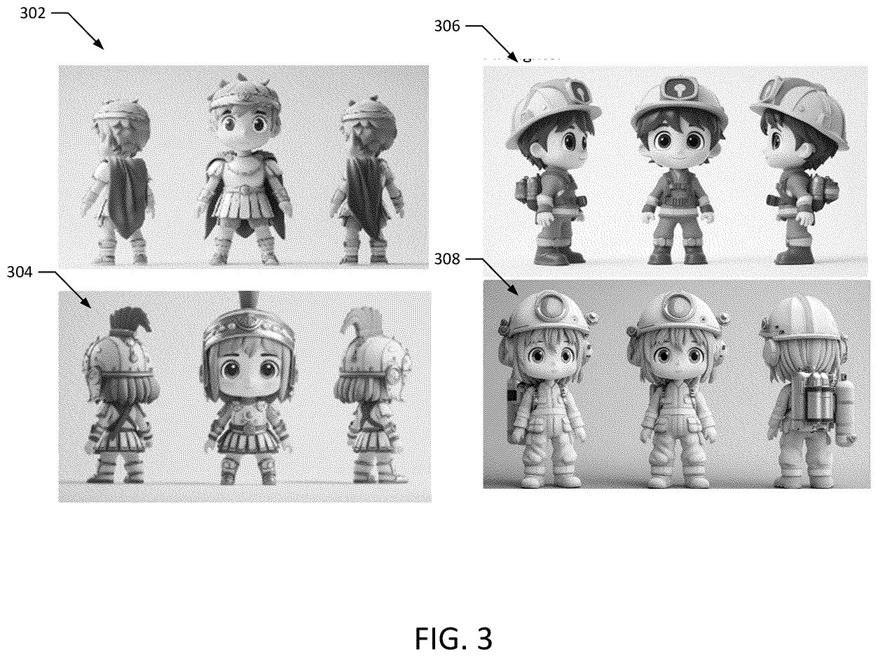

FIG. 3 illustrates physical toy characters 302, 304, 306, 308 according to aspects of the present disclosure. The physical toy characters 302, 304, 306, 308 may be exemplary implementations of the first physical toy character 106 and the second physical toy character 108 described above. These characters may be designed to represent various themes or personas. For example, physical toy characters 302, 304 may represent firefighter figures and physical toy characters 306, 308 may represent Roman soldier figures. The physical toy characters 302, 304, 306, 308 may be a variant featuring distinctive gear and accessories, such as an oxygen tank or firefighting tools for characters 302, 304 or weapons for characters 306, 308. As explained above, such gear may be incorporated into responses generated by the computing devices 102, 104. Each physical toy character 300 may be embedded with an identification carrier or wireless tag, which is not visible in FIG. 3. The wireless tag may include identifiers of the toy characters 302, 304, 306, 308, which may be used when determining responses, as explained above.

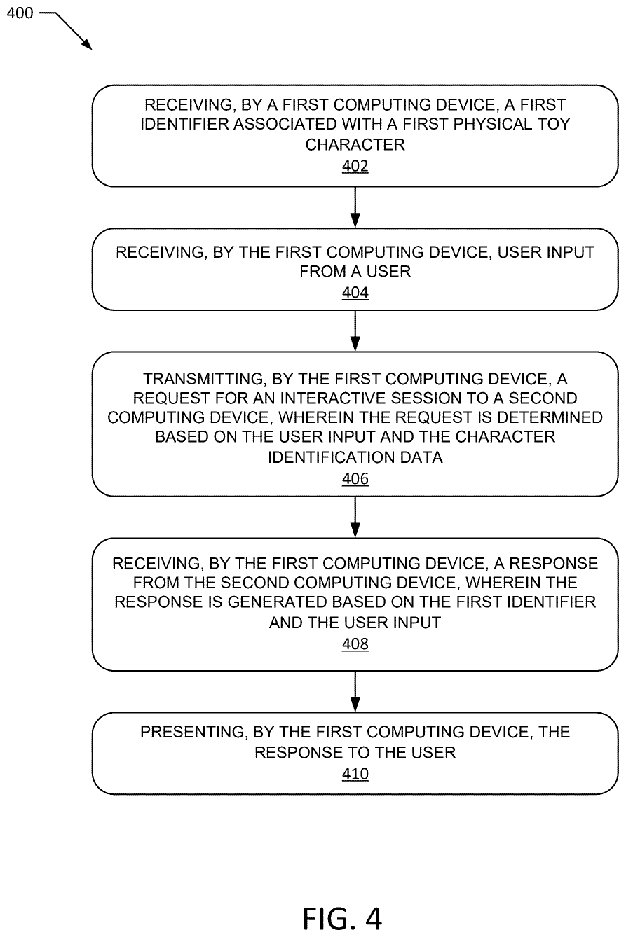

FIG. 4 depicts a method 400 for machine-learning based generative toy interactions according to one aspect of the present disclosure. The method 400 may be implemented on a computer system, such as the system 100. For example, the method 400 may be implemented by the computing device 102. The method 400 may also be implemented by a set of instructions stored on a computer readable medium that, when executed by a processor, cause the computing device to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

The method 400 includes receiving a first identifier associated with a first physical toy character, the first identifier contains character identification data (block 402). For example, the first computing device 102 may receive a first identifier 114 associated with a first physical toy character 106, the first identifier 114 contains character identification data. In certain implementations, detecting the first identifier 114 includes receiving the first identifier 114 from a wireless tag 110 contained within the first physical toy character 106. In certain implementations, the wireless tag 110 may be an NFC tag, an RFID tag, or a combination thereof.

The method 400 includes receiving user input from the user (block 404). For example, the first computing device 102 may receive user input 112 from the user. In certain implementations, the user input 112 may include a selection 124 from a plurality of interaction modes 138, including at least one of a historian mode, a storyteller mode, a face-to-face, an adventure mode, and a biographer mode. In certain implementations, the user input 112 includes audio input 120 captured via a microphone of the first computing device 102 and at least one feature, at least one phrase, at least one keyword, or a combination thereof may be extracted from the audio input 120. In certain implementations, further including performing noise reduction on the audio input 120 prior to transmitting the user input 112 to the second computing device 104.

The method 400 includes transmitting a request to a second computing device 104, the request may be determined based on the user input and the character identification data (block 406). For example, the first computing device 102 may transmit a request 118 for an interactive session to a second computing device 104, the request 118 may be determined based on the user input 112 and the character identification data.

The method 400 includes receiving a response from the second computing device 104, the response may be generated based on the first identifier and the user input (block 408). For example, the first computing device 102 may receive a response 132 from the second computing device 104, the response 132 may be generated based on the first identifier 114 and the user input 112. In certain implementations, the computing device 102 may not receive user input 112. For example, block 404 may be omitted from the method 400. In such instances, transmitting the request 118 at block 406 may include transmitting a request that is determined based on the character identification data (e.g., the identifier 114). Additionally, determining the response at block 408 may include determining the response 132 based on the first identifier 114.

The method 400 includes presenting the response to the user (block 410). For example, the first computing device 102 may present the response 132 to the user. The first computing device 102 may present the response differently based on the contents of the response. In certain implementations, presenting the response to the user includes converting text included in the response into audio data and outputting the audio data via a speaker of the first computing device 102, the first physical toy character 106, or a combination thereof. In certain implementations, presenting the response further includes providing haptic feedback to the user via the first computing device 102. In certain implementations, the haptic feedback may be provided via the first physical toy character 106 through one or more actuators of the first physical toy controlled by the first computing device 102. In certain implementations, the first computing device 102 includes a display screen, and presenting the response to the user includes displaying visual content included in the response on the display screen.

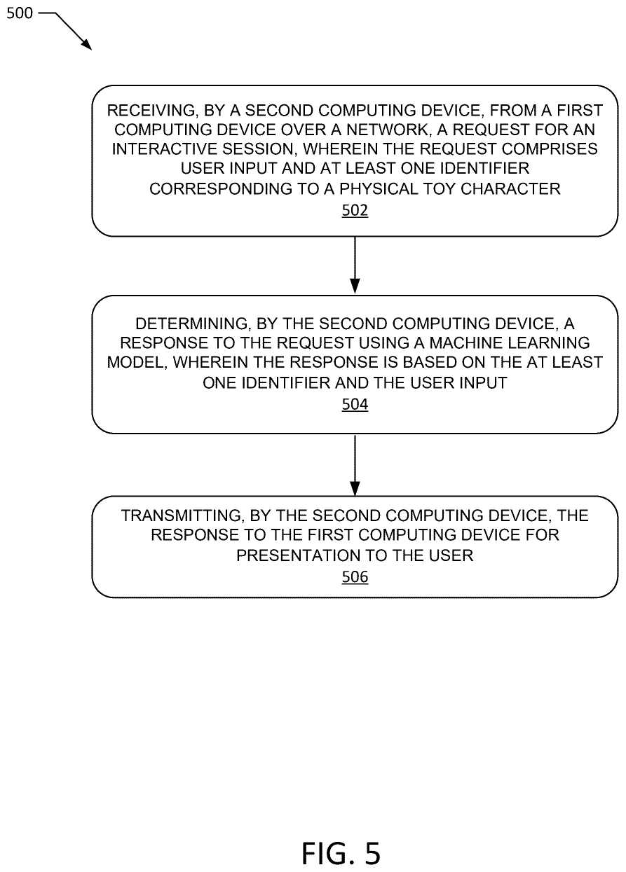

FIG. 5 depicts a method 500 for machine-learning based generative toy interactions according to one aspect of the present disclosure. The method 500 may be implemented on a computer system, such as the system 100. For example, the method 500 may be implemented by the computing device 104. The method 500 may also be implemented by a set of instructions stored on a computer readable medium that, when executed by a processor, cause the computing device to perform the method 500. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks may be optional.

The method 500 includes receiving from a first computing device over a network, a request, the request includes user input and at least one identifier corresponding to a physical toy character (block 502). For example, the second computing device 104 may receive from a first computing device 102 over a network 154, a request 118 for an interactive session, the request 118 includes user input 112 and at least one identifier corresponding to a physical toy character. In certain implementations, the request 118 includes multiple identifiers corresponding to multiple physical toy characters. In such instances, the response 132 may be determined as an interaction between at least two of the multiple physical toy characters.

The method 500 includes determining a response to the request using a machine learning model, the response may be based on the identifier and the user input (block 504). For example, the second computing device 104 may determine a response 132 to the request 118 using a machine learning model 140, and the response 132 may be based on the identifier and the user input 112. In certain implementations, the machine learning model 140 may be trained with curated content specific to the toy character. In certain implementations, the request 118 further may include an indication of an accessory connected to the first physical toy character 106, and processing the user input 112 includes adjusting the response 132 based on the accessory. In certain implementations, retrieving character-specific information 146, character specific settings 128, or a combination thereof may be retrieved from a knowledge base 144. In certain implementations, processing the request 118 includes selecting an interaction mode from a plurality of interaction modes 138. In certain implementations, the user input 112 includes audio data, determining the response 132 may include performing speech recognition on the audio data to determine text data 122 corresponding to the audio data; determining the response 132 based on the text data 122. In certain implementations, the request 118 includes a first identifier 114 associated with a first physical toy character 106 and a second identifier 116 associated with a second physical toy character 108. In such instances, determining the response 132 includes determining a response 132 to include an interaction between the first physical toy character 106 and the second physical toy character 108.

The method 500 includes transmitting the response to the first computing device for presentation to the user (block 506). For example, the second computing device 104 may transmit the response 132 to the first computing device 102 for presentation to the user.

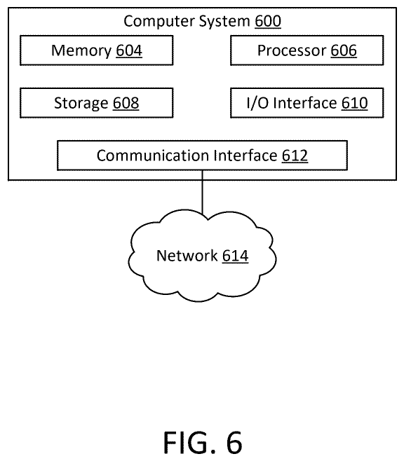

FIG. 6 illustrates an example computer system 600 that may be utilized to implement one or more of the devices and/or components discussed herein, such as the computing device 102, 104. In particular embodiments, one or more computer systems 600 perform one or more steps of one or more methods described or illustrated herein. In particular embodiments, one or more computer systems 600 provide the functionalities described or illustrated herein. In particular embodiments, software running on one or more computer systems 600 performs one or more steps of one or more methods described or illustrated herein or provides the functionalities described or illustrated herein. Particular embodiments include one or more portions of one or more computer systems 600. Herein, a reference to a computer system may encompass a computing device, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 606, memory 604, storage 608, an input/output (I/O) interface 610, and a communication interface 612. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 606 includes hardware for executing instructions, such as those making up a computer program. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular embodiments, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular embodiments, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. Although this disclosure describes and illustrates a particular processor, this disclosure contemplates any suitable processor.

In particular embodiments, the memory 604 includes main memory for storing instructions for the processor 606 to execute or data for processor 606 to operate on. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular embodiments, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular embodiments, one or more memory management units (MMUs) reside between the processor 606 and memory 604 and facilitate accesses to the memory 604 requested by the processor 606. In particular embodiments, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular embodiments, the storage 608 includes mass storage for data or instructions. As an example and not by way of limitation, the storage 608 may include a hard disk drive (HDD), a floppy disk drive, flash memory, an optical disc, a magneto-optical disc, magnetic tape, or a Universal Serial Bus (USB) drive or a combination of two or more of these. The storage 608 may include removable or non-removable (or fixed) media, where appropriate. The storage 608 may be internal or external to computer system 600, where appropriate. In particular embodiments, the storage 608 is non-volatile, solid-state memory. In particular embodiments, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular embodiments, the I/O Interface 610 includes hardware, software, or both, providing one or more interfaces for communication between computer system 600 and one or more I/O devices. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular embodiments, communication interface 612 includes hardware, software, or both providing one or more interfaces for communication (such as, for example, packet-based communication) between computer system 600 and one or more other computer systems 600 or one or more networks 614. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates a particular communication interface implementations, this disclosure contemplates any suitable communication interface implementation.

The computer system 602 may also include a bus. The bus may include hardware, software, or both and may communicatively couple the components of the computer system 600 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving, by a first computing device, a first identifier associated with a first physical toy character and a user input from a user;
transmitting, by the first computing device, a request for an interactive session to a second computing device, wherein the request is determined based on the user input and the first identifier;
receiving, by the first computing device, a response from the second computing device, wherein the response is contextually created using the first identifier and the user input as inputs to a machine learning model that is trained based on a curated data set that is associated with the first physical toy character, and wherein the curated data set includes a speech pattern associated with the first physical toy character; and
presenting, by the first computing device, the response to the user.

2. The method of claim 1, wherein the response comprises newly generated text content, audio content, visual content, or a combination thereof created based on the user input and the first identifier.

3. The method of claim 1, wherein the user input includes a selection from a plurality of interaction modes, including at least one of:
an adventure mode in which the response is determined to include interactive narratives where the user participates in adventures with the first physical toy character;
a biographer mode in which determining the response includes determining a digital twin of the user by collecting personal information associated with the user, wherein the response is determined based on the personal information;
a music mode in which the response may include music generated by artificial intelligence in real time; or
a combination thereof.

4. The method of claim 1, wherein the user input comprises audio input captured via a microphone of the first computing device.

5. The method of claim 1, wherein presenting the response to the user comprises converting text included in the response into audio data and outputting the audio data via a speaker of the first computing device, the first physical toy character, or a combination thereof.

6. The method of claim 1, wherein presenting the response further comprises providing haptic feedback to the user via the first computing device.

7. The method of claim 6, wherein the haptic feedback is provided via the first physical toy character through one or more actuators of the first physical toy character controlled by the first computing device.

8. The method of claim 1, further comprising detecting a second identifier associated with a second physical toy character, and wherein the request is determined based on the first identifier and the second identifier.

9. The method of claim 8, wherein presenting the response comprises outputting an interaction between the first physical toy character and the second physical toy character.

10. The method of claim 1, further comprising extracting, by the first computing device, at least one feature, at least one phrase, at least one keyword, or a combination thereof from the user input, wherein the request includes the at least one feature, at least one phrase, at least one keyword, or a combination thereof.

11. The method of claim 1, wherein detecting the first identifier comprises receiving the first identifier from a wireless tag contained within the first physical toy character.

12. The method of claim 11, wherein the wireless tag is an NFC tag, an RFID tag, or a combination thereof.

13. A method comprising:
receiving, by a second computing device, from a first computing device over a network, a request for an interactive session, wherein the request comprises at least one identifier corresponding to a physical toy character and a user input from a user;
determining, by the second computing device, a response to the request using a machine learning model that is trained based on a curated data set that is associated with the physical toy character, wherein the curated data set includes a speech pattern associated with the physical toy character, and wherein the response is contextually created using the at least one identifier and the user input as inputs to the machine learning model; and
transmitting, by the second computing device, the response to the first computing device for presentation to the user.

14. The method of claim 13, wherein the request comprises a first identifier associated with a first physical toy character and a second identifier associated with a second physical toy character, and wherein determining the response comprises determining a response to include an interaction between the first physical toy character and the second physical toy character.

15. The method of claim 13, wherein the machine learning model is trained based on content specific to at least one character associated with the at least one identifier.

16. The method of claim 13, wherein the request further includes an indication of an accessory connected to the physical toy character, and determining the response comprises adjusting the response based on the accessory.

17. The method of claim 13, wherein the request further includes environmental context data, and wherein the response is determined based on the environmental context data.

18. The method of claim 13, further comprising retrieving information from a knowledge base associated with the physical toy character, wherein the response is contextually created based on the information from the knowledge base associated with the physical toy character.

19. The method of claim 18, further comprising:
retrieving character-specific settings associated with the at least one identifier, the first computing device, the physical toy character, or a combination thereof; and
determining the response based on the character-specific settings.

20-23. (canceled)

24. A system comprising:
a processor; and
a memory storing instructions which, when executed by the processor, cause the processor to perform operations including:
receiving, by a first computing device, a first identifier associated with a first physical toy character and a user input from a user;
transmitting, by the first computing device, a request for an interactive session to a second computing device, wherein the request is determined based on the user input and the first identifier;
receiving, by the first computing device, a response from the second computing device, wherein the response is contextually created using the first identifier and the user input as inputs to a machine learning model that is trained based on a curated data set that is associated with the first physical toy character, and wherein the curated data set includes a speech pattern associated with the first physical toy character; and
presenting, by the first computing device, the response to the user.

25-69. (canceled)

70. The method of claim 13, wherein the response comprises newly generated text content, audio content, visual content, or a combination thereof created based on the user input and the at least one identifier.

71. The method of claim 1, further comprising:
detecting one or more conditions indicating a particular connectivity status associated with network connectivity to the second computing device;
based on detecting the one or more conditions indicating the particular connectivity status, providing the user input to a local machine learning model associated with the first computing device;
receiving an output of the local machine learning model that is based on the user input; and
generating at least one local response at the first computing device based on the output of the local machine learning model.

72. The method of claim 1, wherein the user input includes a selection, from among a plurality of interaction modes, of an adventure mode in which the response is determined to include interactive narratives where the user participates in adventures with the first physical toy character.

73. The method of claim 1, wherein the user input includes a selection, from among a plurality of interaction modes, of a biographer mode in which determining the response includes determining a digital twin of the user by collecting personal information associated with the user, wherein the response is determined based on the personal information.

74. The method of claim 1, wherein the user input includes a selection, from among a plurality of interaction modes, of a music mode in which the response includes music generated by artificial intelligence in real time.
